(19) United States
(12) Patent Application Publication
(10) Pub. No.: US 2006/0280372 A1
(43) Pub. Date: Dec. 14, 2006

(54) Multilayer-based video encoding method, decoding method, video encoder, and video decoder using smoothing prediction

(75) Inventor: Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/450,387

(22) Filed: Jun. 12, 2006

Related U.S. Application Data
(60) Provisional application No. 60/689,087, filed on Jun. 10, 2005.

(30) Foreign Application Priority Data
Aug. 11, 2005 (KR) 10-2005-0073835

(51) Int. Cl. G06K 9/46; G06K 9/40

(52) U.S. Cl. 382/240; 382/268

(57) ABSTRACT

A method and apparatus for decreasing block artifacts in multilayer-based video coding are provided. A multilayer-based video encoding method includes calculating a difference between an inter prediction block for the block of a lower layer picture, which corresponds to an arbitrary block of a current picture, and the block of the lower layer picture, adding the calculated difference to an inter prediction block for the block of the current picture, smoothing a block, which is generated by the adding, using a smoothing filter, and encoding a difference between the block of the current picture and a block generated by the smoothing.

### CROSS-REFERENCE TO RELATED APPLICATIONS

This application claims priority from Korean Patent Application No. 10-2005-0073835 filed on Aug. 11, 2005 in the Korean Intellectual Property Office, and U.S. Provisional Patent Application No. 60/689,087 filed on Jun. 10, 2005 in the United States Patent and Trademark Office, the disclosures of which are incorporated herein by reference in their entirety.

### BACKGROUND OF THE INVENTION

1. Field of the Invention

Apparatuses and methods consistent with the present invention relates generally to video coding technology and, more particularly, to a method and apparatus for decreasing block artifacts in multilayer-based video coding.

2. Description of the Related Art

As information and communication technology, including the Internet, develops, image-based communication as well as text-based communication and voice-based communication is increasing. The existing text-based communication is insufficient to satisfy consumers' various demands. Therefore, the provision of multimedia service capable of accommodating various types of information, such as text, images and music, is increasing. Since the amount of multimedia data is large, multimedia data requires high-capacity storage media and requires broad bandwidth at the time of transmission. Therefore, to transmit multimedia data, including text, images and audio, it is essential to compress the data.

The fundamental principle of data compression is to eliminate redundancy in data. Data can be compressed by eliminating spatial redundancy, such as the case where the same color or object is repeated in an image, temporal redundancy, such as the case where there is little change between neighboring frames or the same audio sound is repeated, or psychovisual redundancy in which the fact that humans' visual and perceptual abilities are insensitive to high frequencies is taken into account. In a general coding method, temporal redundancy is eliminated using temporal filtering based on motion compensation, and spatial redundancy is eliminated using spatial transform.

In order to transmit multimedia data after the redundancy of data has been removed, transmission media are necessary. Performance differs according to transmission medium. Currently used transmission media have various transmission speeds ranging from the speed of an ultra high-speed communication network, which can transmit data at a transmission rate of several tens of megabits per second, to the speed of a mobile communication network, which can transmit data at a transmission rate of 384 Kbits per second. In these environments, a scalable video encoding method, which can support transmission media having a variety of speeds or can transmit multimedia at a transmission speed suitable for each transmission environment, is required.

Such a scalable video coding method refers to a coding method that allows a video resolution, a frame rate, a Signal-to-Noise Ratio (SNR), etc. to be adjusted by truncating part of an already compressed bitstream in conformity with surrounding conditions, such as a transmission bit rate, a transmission error rate, a system source, etc.

Currently, in order to implement multi-layer type of scalability based on H.264, standardization (hereinafter referred to as “H.264 Scalable Extension (SE)”) is in progress in the Joint Video Team (JVT), which is the working group of the Moving Picture Experts Group (MPEG) and the International Telecommunication Union (ITU).

The H.264 SE and a multilayer-based scalable video codec basically support four prediction modes, that is, inter prediction, directional intra prediction (hereinafter simply referred to as “intra prediction”), residual prediction and intra-base prediction. The term “prediction” implies a technique of compressively representing original data using prediction data generated based on information that can be commonly used in an encoder and a decoder.

Of the four prediction modes, inter prediction is a prediction mode that is generally used in a video codec having an existing single-layer structure. The inter prediction, as shown in FIG. 1, is a method of searching at least one reference picture for a block closest to an arbitrary block (current block) of a current picture, acquiring a prediction block that can best represent the current block from the search, and quantizing a difference between the current block and the prediction block.

Inter predictions are classified into bi-directional prediction for which two reference pictures are used, forward prediction for which a previous reference picture is used, and backward prediction for which a subsequent reference picture is used, according to the method of making reference to a reference picture.

Meanwhile, the intra prediction is a prediction method that can be used even in a single-layer based video codec based on H.264. Furthermore, the intra prediction is a method of predicting a current block using pixels neighboring the current block, which belong to neighboring blocks around the current block. The intra prediction differs from other prediction methods in that it uses only information about the current picture, and does not make reference to the other pictures of the same layer and the pictures of other layers.

The intra-base prediction may be used in the case where a lower layer picture (hereinafter referred to as a “base picture”), having a temporal location identical to a current picture, exists in a video codec having a multi-layer structure. As shown in FIG. 2, the macroblock of the current picture can be efficiently predicted from the macroblock of the base picture corresponding to the macroblock of the current picture. That is, a difference between the macroblock of the current picture and the macroblock of the base picture is quantized.

If the resolution of the lower layer and the resolution of a current layer are different from each other, the resolution of the base picture must be up-sampled into the resolution of the current layer before the obtainment of a difference. Such an intra-base prediction is particularly efficient in the case where the efficiency of the inter prediction is not high, for example, in images in which motion is very fast or in images in which scene conversion occurs. Finally, inter prediction with residual prediction (hereinafter simply called “residual prediction”) is a prediction method in which the existing inter prediction in a single layer is extended to a multilayer form. According to the residual prediction method of FIG. 3, a difference generated by the current layer inter prediction process is not directly quantized, a difference generated by the current layer and a difference generated by a lower layer inter prediction process are subtracted from each other again, and a result obtained by the subtraction is quantized.

In consideration of various video sequence characteristics, the most efficient of the above-described four prediction methods is used for respective macroblocks forming a picture. For example, the inter prediction and the residual prediction may be chiefly used for a video sequence in which motion is slow. In contrast, the intra-base prediction may be chiefly used for a video sequence in which motion is fast.

The video codec having the multi-layer structure has a relatively complicated prediction structure compared to a video codec having a single-layer structure and chiefly employs an open-loop structure, so that a lot of block artifacts appear in contrast to the codec having the single-layer structure. Particularly, the above-described residual prediction uses the residual signals of the lower layer picture, so that excessive distortion may occur in the case where the characteristics of the residual signals are greatly different from those of the inter prediction signals of the current layer picture.

In contrast, when the intra-base prediction is performed, prediction signals for the macroblock of the current picture, that is, the macroblock of the base picture, are not original signals, and are restored signals after quanization. Accordingly, the prediction signals are signals that can be obtained in common by both an encoder and a decoder, so that encoder-decoder mismatch does not occur. In particular, a difference with the macroblock of the current picture is obtained using a smoothing filter for the prediction signals, so that block artifacts are considerably reduced.

However, according to a low-complexity decoding condition that has been adopted as in the working draft of the current H.264 SE, the use of the intra-base prediction is limited. That is, H.264 SE allows intra-base prediction to be used in the case where a specific condition is satisfied, so that only decoding can be performed in a manner similar to that in a video codec having a single-layer structure, although encoding is performed in a multi-layer form.

According to the low-complexity decoding condition, the intra-base prediction is used only in the case where the type of the macroblock of the lower layer, corresponding to the arbitrary macroblock of the current layer, is an intra prediction mode or an intra-base prediction mode. This is to reduce the amount of operation depending on a motion compensation process that occupies the largest amount of operation in a decoding process. In contrast, a problem occurs in that performance for images in which motion is fast is lowered because the intra-base prediction is limitedly used.

Accordingly, in the case where the inter prediction or the residual prediction is used according to the low-complexity condition or other conditions, technology capable of reducing various distortions, such as encoder-decoder mismatch and block artifacts, is necessary.

### SUMMARY OF THE INVENTION

Accordingly, as aspect of the present invention relates to improving coding performance when inter prediction or residual prediction is performed in a multilayer-based video codec.

The present invention provides a multilayer-based video encoding method, including the steps of (a) calculating a difference between an inter prediction block for the block of a lower layer picture, which corresponds to an arbitrary block of a current picture, and the block of the lower layer picture; (b) adding the calculated difference to an inter prediction block for the block of the current picture; (c) smoothing a block, which is generated by the adding, using a smoothing filter; and (d) encoding a difference between the block of the current picture and a block generated by the smoothing.

In addition, the present invention provides a multilayer-based video encoding method, including the steps of (a) generating an inter prediction block for an arbitrary block of a current picture; (b) smoothing the generated inter prediction block using a smoothing filter; (c) calculating a difference between the block of the current picture and a block generated by the smoothing; and (d) encoding a difference.

In order to accomplish the above, the present invention provides a multilayer-based video decoding method, comprising the steps of (a) restoring the residual signals of an arbitrary block of a current picture, which is contained in an input bitstream, based on texture data for the block of the current picture; (b) restoring the residual signals of the block of a lower layer picture, which is contained in the bitstream and corresponds to the block of the current picture; (c) adding the residual signals, which are restored at step (b), to an inter prediction block for the current picture; (d) smoothing a block, which is generated by the adding, using a smoothing filter; and (e) adding the residual signals, which are restored at step (a), to a block generated by the smoothing.

The present invention also provides a multilayer-based video encoder, including a means for generating an inter prediction block for an arbitrary block of a current picture; a means for smoothing the generated inter prediction block using a smoothing filter; a means for calculating a difference between the block of the current picture and a block generated by the smoothing; and a means for encoding a difference.

The present invention further provides a multilayer-based video encoder, including a means for restoring the residual signals of an arbitrary block of a current picture, which is contained in an input bitstream, based on texture data for the block of the current picture; a means for restoring the residual signals of the block of a lower layer picture, which is contained in the bitstream and corresponds to the block of the current picture; a means for adding the residual signals, which are restored at step (b), to an inter prediction block for the current picture; a means for smoothing a block generated by the adding using a smoothing filter; and a means for adding the residual signals, which are restored at step (a), to a block generated by the smoothing.

### BRIEF DESCRIPTION OF THE DRAWINGS

The above aspects of the present invention will be more clearly understood from the following detailed description taken in conjunction with the accompanying drawings, in which:

FIG. 1 is a diagram illustrating a related method;

FIG. 2 is a diagram illustrating a related intra-base prediction method;

FIG. 3 is a diagram illustrating a related residual prediction method;

FIG. 4 is a diagram illustrating a smoothing prediction method according to an exemplary embodiment of the present invention;

FIG. 5 is a diagram showing an example of applying a smoothing filter to the vertical boundary of a sub-block having a size of 4×4 pixels;

FIG. 6 is a diagram showing an example of applying a smoothing filter to the lateral boundary of a sub-block having a size of 4×4 pixels;

FIG. 7 is a block diagram showing the construction of a video encoder according to an exemplary embodiment of the present invention;

FIG. 8 a block diagram showing the construction of a video decoder according to an exemplary embodiment of the present invention; and

FIG. 9 is a diagram showing the construction of a system for implementing the video encoder of FIG. 7 and the video decoder of FIG. 8.

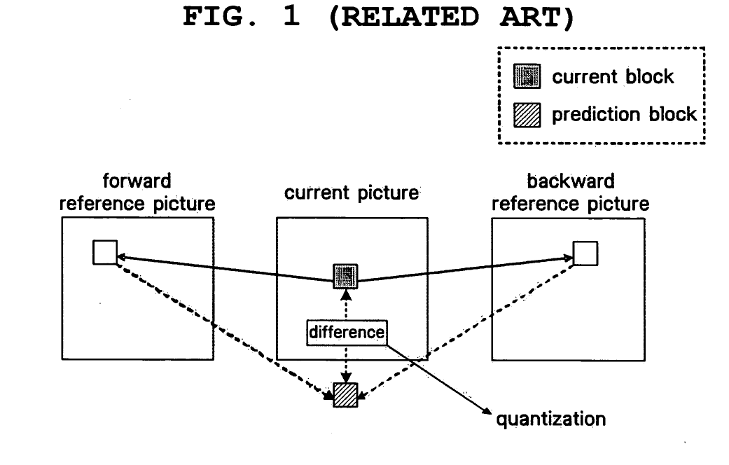

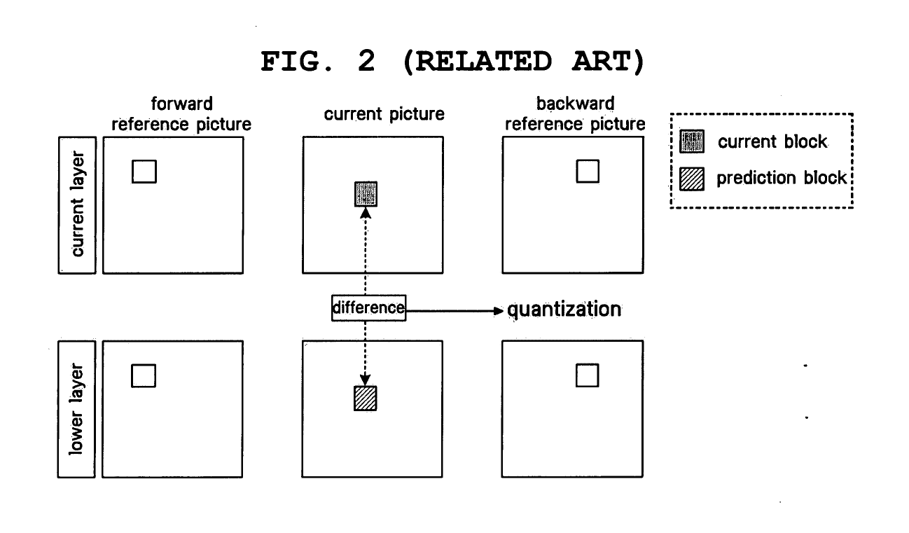

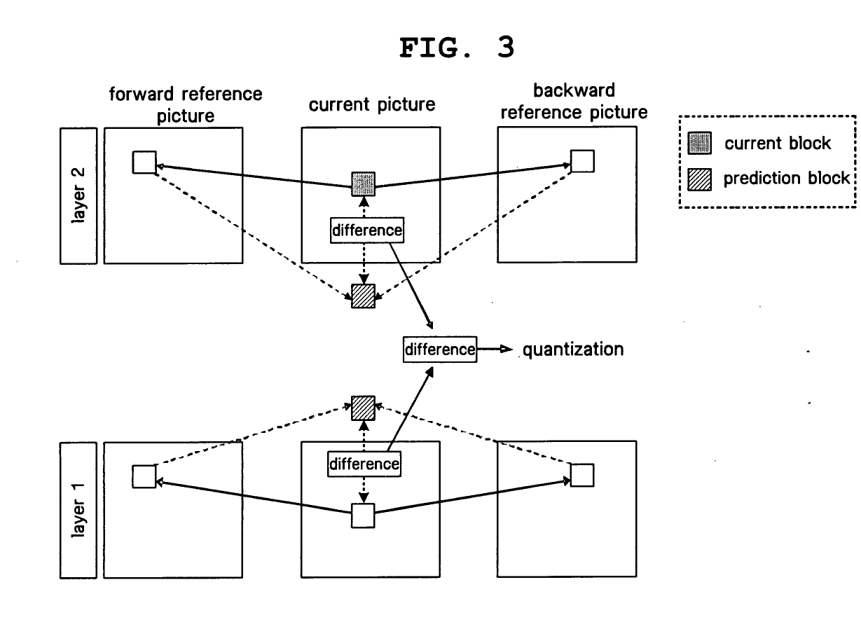

### DESCRIPTION OF THE EXEMPLARY EMBODIMENTS

Aspects of the present invention, and a method of achieving them, will be apparent with reference to exemplary embodiments described in detail later in conjunction with accompanying drawings. However, the present invention is not limited to the exemplary embodiments disclosed below, but may be implemented in various ways. Furthermore, the exemplary embodiments are provided to complete the disclosure of the present invention, and to fully notify those skilled in the art of the scope of the present invention. The present invention is defined only by the appended claims. The same reference numerals are used throughout the different drawings to designate the same or similar components.

Assuming that the block of a current picture is O_{F}, a prediction block obtained by performing inter prediction on the current picture is P_{F}, the block of a base picture corresponding to the block of the current picture is O_{B}, and a prediction block obtained by performing inter prediction on the base picture is P_{B}, residual signals R_{B}, which are contained in the block O_{B}, are obtained by subtracting the prediction block P_{B} from the block O_{B}.

in this case, the blocks O_{B}, P_{B}, and R_{B} are values restored after already being quantized, and the blocks O_{F} and P_{F} imply original signals in the case of an open-loop method, and values restored after already being quantized in the case of a closed-loop method. In this case, assuming that a value desired to be coded in the current picture is R_{F}, residual prediction can be expressed by the following Equation 1:
R_{F}=O_{F}−P_{F}−R_{B} (1)

Meanwhile, intra-base prediction can be expressed by the following Equation 2:
R_{F}=O_{F}−O_{B} (2)

When Equations 1 and 2 are compared to each other, they seem not to have a common point at first glance. However, when the equations are expressed by the following Equations 3 and 4, respectively, the similarity therebetween can be found.
R_{F}=O_{F}−(P_{F}+R_{B}) (3)
R_{F}=O_{F}−[U]·B(P_{B}+R_{B}) (4)

In Equation 4, the symbol U indicates an up-sampling function, and the symbol B indicates a deblock function. Since the up-sampling function is used in the case where the resolution of the current layer and the resolution of the lower layer are different from each other, the up-sampling function is expressed by the symbol [U] in the sense that it can be selectively used.

Upon comparing Equations 3 and 4, R_{B} is common in both Equations, and the most significant difference is that the inter prediction block P_{F} of the current layer is used in Equation 3, and the inter prediction block P_{B} of the lower layer is used in Equation 4. Furthermore, in the intra-base prediction, when the deblock function and the up-sampling function are used, the image of a restored picture is smoothened, so that block artifacts decrease.

In Equation 3, the residual signals R_{B} of the base picture, which is obtained using P_{B}, is added to the block P_{F} obtained by performing inter prediction on the current picture and, therefore, mismatch between layers or block artifacts can occur. Although the problems may be alleviated if intra-base prediction is used, intra-base prediction cannot be used in the case where the efficiency of the intra-base prediction is not high in contrast to the residual prediction. Furthermore, in the case where a low-complexity decoding condition is used, blocks for which the intra-base prediction is not used increase even in the situation in which the intra-base prediction is efficient, so that performance is remarkably deteriorated. Accordingly, a method of reducing block artifacts while applying the residual prediction to the case must be considered.

In the present invention, a smoothing function F is additionally assigned to Equation 3 and, therefore, the existing residual prediction can be complemented. In accordance with the present invention, the data R_{F} of a current block to be quantized is expressed by the following Equation 5:
R_{F}=O_{F}−F(P_{F}+R_{B}) (5)

A prediction mode based on Equation 5 may be applied to the inter prediction without change. That is, the prediction mode can be regarded as the case where the R_{B} is 0 in the inter prediction, R_{F} can be expressed by the following Equation 6:
R_{F}=O_{F}−F(P_{F}) (6)

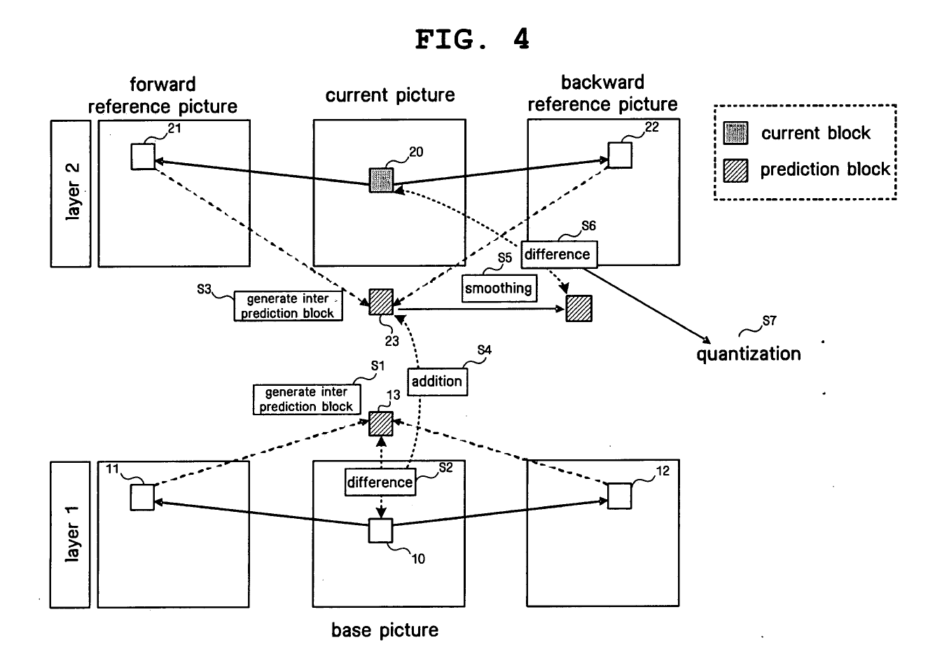

From Equations 5 and 6 described above, a method of employing the smoothing filter when the existing residual prediction or inter prediction is performed is defined as the term “smoothing prediction”. A process of performing the smoothing prediction is described in more detail with reference to FIG. 4. In FIG. 4, a process of encoding an arbitrary block of the current picture 20 (hereinafter referred to as a “current block”) is exemplified. The block 10 in the base picture, which corresponds to the current block 20, is named “base block.”

First, at step S1, the inter prediction block 13 for the base block 10 is generated using the base block 10, and blocks 11 and 12 in the neighboring reference pictures (forward reference picture and backward reference picture) of the lower layer, which correspond to the base block 10 based on motion vectors. Thereafter, a difference (corresponding to R_{B} in Equation 5) between the base block 10 and the prediction block 13 is calculated at step S2. Meanwhile, at step S3, an inter prediction block 23 (corresponding to P_{F} in Equation 5) for the current block 20 is generated using the current block 20, and blocks 21 and 22 in the neighboring reference pictures of the current layer, which correspond to the current block 20 based on motion vectors. Step S3 may be performed prior to steps S1 and S2. Generally, the term “inter prediction block” refers to a prediction block for the block that is acquired from an image (or images) on a reference picture corresponding to an arbitrary block within a picture desired to be encoded picture. The correspondence relationship between the block and the image is indicated by a motion vector. Generally, the inter prediction block refers to an corresponding image itself in the case of a single reference picture, and refers to the weighted sum of corresponding images in the case of a plurality of reference pictures.

Thereafter, the prediction block 23 and a difference obtained at step S2 are added at step S4. A block (corresponding to P_{F}+R_{B} in Equation 5) generated as the result of the adding, is smoothened using a smoothing filter at step S5. Finally, a difference between the current block 20 and a block (corresponding to F(P_{F}+R_{B}) in Equation 5) generated as the result of the smoothing is calculated at step S6, and then a difference is quantized at step S7.

FIG. 4 illustrates a smoothing prediction process based on the residual prediction. If a smoothing prediction process based on the inter prediction is far more simplified than this process, all steps S1, S2 and S4 described in conjunction with FIG. 4 may be omitted because R_{B}, related to calculation on the lower layer, is omitted from Equation 5. Accordingly, the inter prediction block 23, generated based on the current layer, is smoothened using the smoothing filter, and then a difference between the current block 20 and a block (corresponding to F(P_{F}) in Equation 6) generated by the smoothing is quantized.

Meanwhile, different types of smoothing filters actually applied to the smoothing prediction may be used. First, a smoothing function based on Equation 4 can be considered. The smoothing function (F) may be formed of only the deblock function (B) in the simplest manner, or includes the deblock function (B) and functions (U·D).

When the resolution of the current layer and the resolution of the lower layer are different from each other, functions (U·D·B) may be applied, that is, the deblock function (B) is applied, and then the down-sampling function (D) and the up-sampling function (U) are subsequently applied. In contrast, when the resolutions of the layers are the same, the deblock function (B) is simply applied. In sum, Equation 7 is as follows:
when the resolutions of the layers are differnt: F=U·D·B
when the resolutions of the layers are the same F=B (7)

Since F is a function applied to the resolution of the current layer, the down-sampling function (D) is applied prior to the application of the up-sampling function (U). By doing so, even in the inter prediction or the residual prediction, block artifacts can be effectively eliminated as in the intra-base prediction.

Meanwhile, since each of the deblock function (D) and the up-sampling function (U) chiefly performs a smoothing task, the tasks overlap each other. Furthermore, the deblock function, the up-sampling function, and the down-sampling function require the considerable amount of operations at the time of application, and the down-sampling function assumes a role of very strong low-pass filtering, so that the details of an image obtained when prediction is performed can be deteriorated.

Accordingly, the smoothing filter (F) allows boundary pixels and their neighboring pixels to be represented in a linear coupling form so that the process of applying the smoothing filter is performed by a small amount of operations.

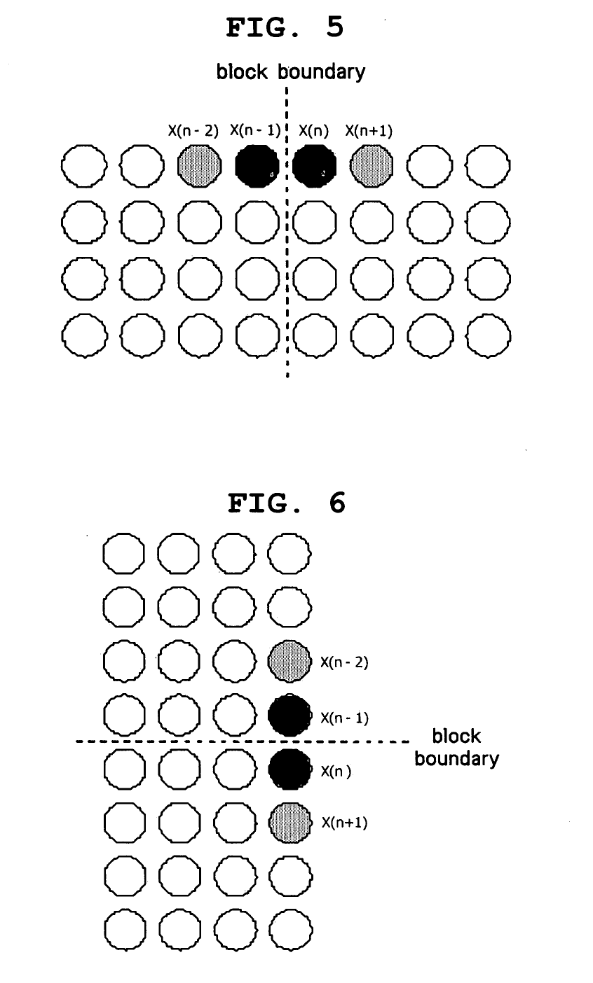

FIGS. 5 and 6 are diagrams illustrating the application examples of the smoothing filter, and show examples of applying the smoothing filter to the vertical boundary and lateral boundary of sub-blocks, each having a 4×4 size. In FIGS. 5 and 6, boundary pixels x(n−1) and x(n) can be smoothened in a form in which the boundary pixels and their neighboring pixels are linearly coupled. If results, obtained when the smoothing filter is used for the pixels x(n−1) and x(n), are represented by x′(n−1) and x′(n), x′(n−1) and x′(n) can be expressed by the following Equation 8:
x′(n−1)=α*x(n−2)+β*x(n−1)+γ*x(n)
x′(n)=γ*x(n−1)+β*x(n)+α*x(n+1) (8)
where α*, β*, and γ* can be appropriately selected such that the sum thereof is 1. For example, when α*=¼, β*=½, and γ*=¼ in Equation 8, the weighted value of a corresponding pixel can increase in contrast to neighboring pixels. In Equation 8, a further host of pixels may be selected to be neighboring pixels.

When such a simple type of smoothing filter (F) is used, the amount of operations are greatly reduced, and an image detail deterioration phenomenon, which is generated when down-sampling is performed, can be prevented to some extent.

The smoothing prediction method described above may be selectively used along with the four existing prediction methods. The reason that the smoothing prediction method is selectively used is because the smoothing prediction method exerts an effect when it is used for an image for which the characteristics of the blocks P_{F} and R_{B} do not match each other well, while the deterioration of performance may result when the smoothing prediction method is used for an image for which the characteristics of the blocks P_{F} and R_{B} match each other.

Accordingly, flags are respectively provided for macroblocks, and the encoder is allowed to selectively use the smoothing prediction method and the existing prediction methods based on the values of the flags. The decoder reads the flags, thus determining whether the smoothing prediction has been used. Generally, the number of blocks from which artifacts occur is not too many in contrast to overall blocks, so that it is expected that a image quality improvement effect, which can be acquired by eliminating the block artifacts, is greater than that acquired from overhead bits that occur due to the adding of the flags.

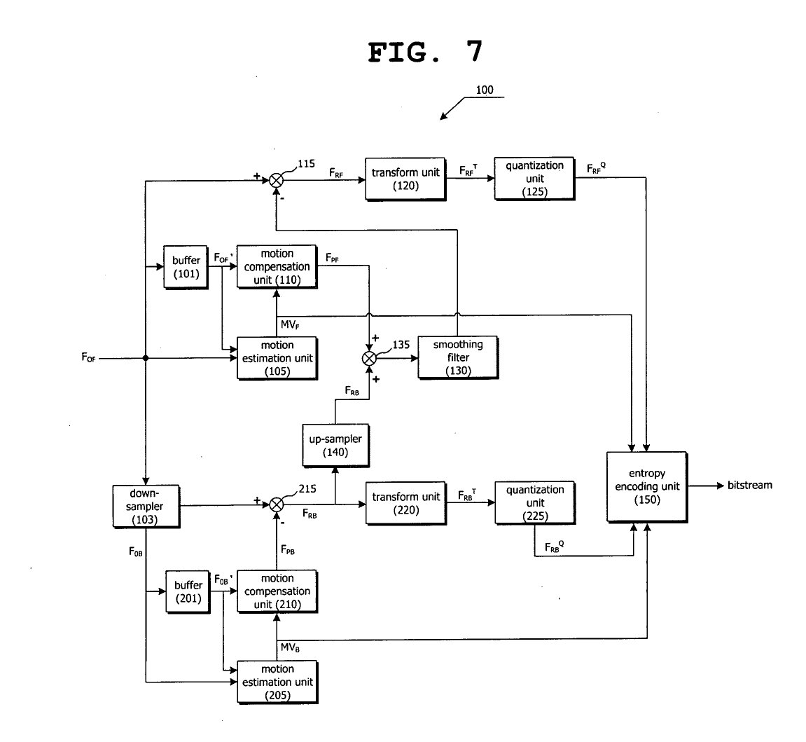

FIG. 7 is a block diagram showing the construction of a video encoder 100 according to an exemplary embodiment of the present invention. In the descriptions of the Equations 1 to 8, the descriptions are made based on blocks (macroblocks or sub-blocks) constituting a picture. However, in the following description, a description is made in the point of view of a picture including the blocks. For the unification of expressions, a block identifier is represented using a subscript of character “F” that indicates a picture. For example, a picture, including a block R_{B}, is represented by F_{RB}.

An operational process performed by the video encoder 100 may be classified into four steps. The operational process includes the first step of calculating a difference between an inter prediction block for the block of a lower layer picture, which corresponds to an arbitrary block of a current picture, and the block of the lower layer picture the second step of adding the calculated difference to an inter prediction block for the block of the current picture, the third step of smoothing a block, which is generated by the adding, using a smoothing filter, and the fourth step of encoding a difference between the block of the current picture and a block generated by the smoothing.

First, the first step is described. A current picture F_{OF} is input to a motion estimation unit 105, a buffer 101, a subtractor 115, and a down-sampler 103.

The down-sampler 103 performs spatial and/or temporal down-sampling on the current picture F_{OF} and generates a lower layer picture F_{OB}.

A motion estimation unit 205 performs motion estimation on the lower layer picture F_{OB} with reference to neighboring pictures F_{OB′}, thus obtaining motion vectors MV_{B}. The above-described neighboring pictures are called “reference pictures.” Generally, a block matching algorithm is widely used to performs motion estimation. That is, a displacement, obtained when an error is minimized while moving a given block within the specific search area of a reference picture on a pixel basis or a sub-pixel (2/2 pixel, ¼ pixel, etc.) basis, is estimated as a motion vector. A fixed-size block matching method may be used to perform motion estimation, and a hierarchical method based on a Hierarchical Variable Size Block Matching (HVSBM), such as H.264, may also be used.

If the video encoder 100 is formed in the form of an open loop codec, the original neighboring picture F_{OB′} stored in a buffer 201 is used as a reference picture without change. In contrast, if the video encoder 100 is formed in the form of a closed loop codec, a decoded picture after encoding (not shown) is used as a reference picture. In the present specification, a description is made based on the open loop codec, but is not limited thereto.

The motion vectors MV_{B} obtained by the motion estimation unit 205 are provided to a motion compensation unit 210. The motion compensation unit 210 compensates for the motion of the reference picture FOB′ using the motion vectors MV_{B}, and generates a prediction picture F_{PB} for the current picture. When a bi-directional reference is used, the prediction picture may be obtained by calculating the average of a motion-compensated reference picture. In contrast, when a unidirectional reference is used, the prediction picture may be the same as the motion-compensated reference picture. The prediction picture F_{PB} is composed of a plurality of inter prediction blocks P_{B}.

Meanwhile, a subtractor 215 calculates a difference between the lower layer picture FOB and the prediction picture F_{PB}, and generates a residual picture F_{RB}. From a point of view of a block basis, such a difference calculation process may be referred to as a process of calculating a difference between a block O_{B}, which is contained in the lower layer picture F_{OB}, and a residual block R_{B}, which is contained in the prediction picture F_{PB}. The prediction picture F_{PB} is provided to an adder 135. If the resolutions of layers are different to each other, the prediction picture F_{PB} is up-sampled to the resolution of a current layer by an up-sampler 140 and is then provided to the adder 135.

Thereafter, the second step is described. The current picture F_{OF} is input to the motion estimation unit 105, the buffer 101, and the subtractor 115. The motion estimation unit 105 performs motion estimation on the current picture with reference to a neighboring picture reference, thus obtaining motion vectors MV_{F}. Since the process of performing motion estimation is the same as that occurring in the motion estimation unit 205, a repeated description is omitted.

The motion vectors MV_{F} obtained by the motion estimation unit 105 are provided to a motion compensation unit 110. The motion compensation unit 110 compensates for the motion of a reference picture F_{OF′} using the motion vectors MV_{F}, and generates a prediction picture F_{PF} for the current picture.

Thereafter, an adder 135 adds the prediction picture F_{PF} and the residual picture FR_{B} provided from the lower layer. From a point of view of a block basis, the addition process may be referred to as a process of adding an inter prediction block P_{F}, which is contained in the prediction picture F_{PF}, and the residual block R_{B}, which is contained in the residual picture F_{RB}.

Thereafter, the third step is described. A smoothing filter unit 130 smoothes the output F_{PF}+F_{RB} of the adder 135 using a smoothing filter.

A smoothing function for the smoothing filter may be implemented in various forms. For example, as described in Equation 7, when the resolutions of layers are the same, a deblock function may be used without change as the smoothing function for the smoothing filter. In contrast, when the resolutions of layers are different, a combination of a deblock function, a down-sampling function and an up-sampling function may be used as the smoothing function.

Furthermore, the smoothing function may have a form in which the boundary pixels of the smoothened block and their neighboring pixels are linearly coupled, as described in Equation 8. In particular, the neighboring pixels, as shown in FIGS. 5 and 6, are pixels that neighbor the boundary pixels, a weighted value of each of the boundary pixels may be defined as ½, and a weighted value of each of the neighboring pixels may be defined as ¼.

Finally, the fourth step is described. The subtractor 115 generates a difference F_{RF} between the current picture F_{OF} and a picture generated by the smoothing. From a point of view of a block basis, the process of generating a difference may be referred to as a process of performing subtraction on the block O_{F}, which is contained in the current picture F_{OF}, and a block (F(P_{F}+R_{B}) of Equation 5, which is generated by the smoothing.

The transform unit 120 performs spatial transform on the deferential picture F_{RF}, and generates transform coefficients F_{RF}^{T}. The spatial transform method may employ Discrete Cosine Transform (DCT), wavelet transform or the like. The transform coefficients may be DCT coefficients in the case where the DCT is used, and the transform coefficients may be wavelet coefficients in the case where the wavelet transform is used.

The quantization unit 125 quantizes the transform coefficients. The quantization refers to a process of converting the transform coefficients, which are expressed by arbitrary real number values, into discrete values. For example, the quantization unit 125 performs quantization in such a manner as to divide the transform coefficients, which are expressed by arbitrary real number values by a predetermined quantization step, and then round off the divided results to integer values.

Meanwhile, the residual picture F_{RB} of the lower layer is converted into quantization coefficients F_{RB}^{Q} via a transform unit 220 and a quantization unit 225.

The entropy encoding unit 150 encodes the motion vectors MV_{F} estimated by the motion estimation unit 105, the motion vectors MV_{B} estimated by the motion estimation unit 205, quantization coefficients F_{RF}^{Q} provided by the quantization unit 125, and the quantization coefficients F_{RB}^{Q} provided by the quantization unit 225 without loss, and generates a bitstream. Such a lossless encoding method may employ Huffman coding, arithmetic coding, variable length coding, and various other methods.

The bitstream may further include a flag for indicating whether the quantization coefficients F_{RF}^{Q} have been encoded by the smoothing prediction proposed by the present invention, that is, whether the quantization coefficients F_{RF}^{Q} have been encoded through steps 1 to 4.

Until now, a process of actually implementing the numerical formula of Equation 5 has been described in conjunction with FIG. 7. The present invention is not limited to this, and may be implemented based on the numerical formula of Equation 6 in consideration of the case where R_{B} is set to “0” in Equation 5, that is, the characteristics of a single layer. This is a method that can be applied to the single layer, and may be implemented in such a manner that the operational process of the lower layer is omitted in FIG. 7, and the prediction picture F_{PF}, which is output from the motion compensation unit 110, is directly input to the smoothing filter 130 without passing through the adder 135. Accordingly, a separate drawing is not provided.

A video encoding method according to the above-described exemplary embodiment may include the steps of generating an inter prediction block for an arbitrary block of a current picture, smoothing the generated inter prediction block using a smoothing filter, calculating a difference between the block of the current picture and a block generated by the smoothing, and encoding a difference.

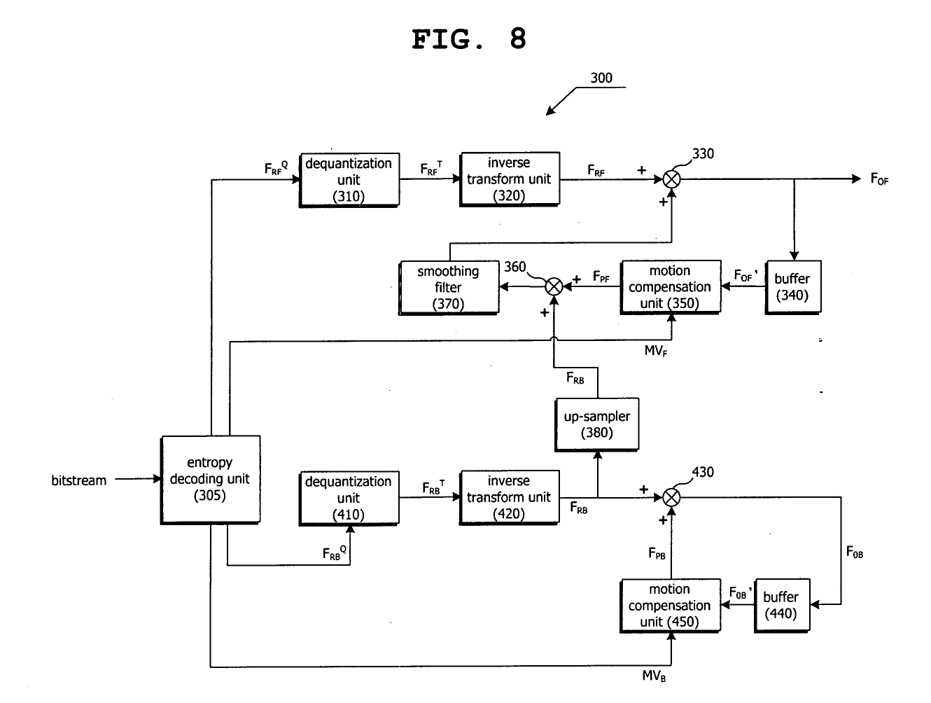

FIG. 8 is a block diagram showing the construction of a video decoder 300 according to an exemplary embodiment of the present invention.

An operational process, which is performed by the video encoder 100, can be divided into five steps. The operational process includes the first step of restoring residual signals of the arbitrary block of the current picture, which is contained in an input bitstream, based on texture data for the block of the current picture, the second step of restoring the residual signals of the block of the lower layer picture, which is contained in the bitstream and corresponds to the block of the current block, the third step of adding the residual signals, which are restored at the second step, to an inter prediction block for the current picture, the fourth step of smoothing a block, which is generated by the adding, using a smoothing filter, and the fifth step of adding the residual signals, which are restored at the first step, to a block generated by the smoothing.

First, the first step is described below. An entropy decoding unit 305 decodes an input bitstream without loss, the texture data F_{RF}^{Q} of the current picture, the texture data F_{RB}^{Q} of the lower layer picture (a picture having a temporal location identical to the current picture), the motion vectors MV_{F} of the current picture, and the motion vectors MV_{B} of the lower layer picture. The lossless decoding is a process that is performed in a reverse order to that of the lossless encoding process of the encoder.

In this case, the following operational steps may be performed in the case where the flag of the video encoder 100 is contained in the bitstream, and the flag indicates that encoding has been performed using the smoothing prediction proposed in the present invention.

The texture data F_{RF}^{Q} of the current picture is provided to a dequantization unit 310, and the texture data F_{RB}^{Q} of the lower layer picture is provided to a dequantization unit 410. The motion vectors MV_{F} of the current picture are provided to a motion compensation unit 350, and the motion vectors MV_{B} of the lower layer picture are provided to a motion compensation 450.

The dequantization unit 310 dequantizes the provided texture data F_{RF}^{Q} of the current picture. The dequantization process is a process of restoring a value matching from an index, which is generated by a quantization process, using a quantization table that is used in the quantization process.

An inverse transform unit 320 performs dequantization on the results of the dequantization. The inverse transform process is performed in a reverse order to that of the transform process of the encoder and, specifically, may employ inverse DCT, inverse wavelet transform or the like.

As the result of the inverse transform, a residual picture F_{RF} with respect to the current picture is restored. The residual picture F_{RF} is composed of a plurality of residual signals R_{F}, that is, a plurality of residual blocks.

Meanwhile, the second step is described below. A dequantization unit 410 dequantizes the provided texture data F_{RB}^{Q} of the lower layer picture, and an inverse transform unit 420 performs inverse transform on the results of the dequantization. As the result of the transform, a residual picture F_{RB} with respect to the lower layer picture is restored. The residual picture FRB is composed of a plurality of residual signals R_{B}.

The restored residual picture F_{RB} is provided to an adder 360. In this case, when the resolutions of layers are different from each other, the residual picture FRB is up-sampled to the resolution of the current layer by an up-sampler 380 and is then provided to the adder 360.

Thereafter, the third step is described below.

The motion compensation unit 350 performs motion compensation on a reference picture F_{OF′} provided from a buffer 340 using the motion vectors MV_{F}, thus generating an inter prediction picture F_{PF}. The reference picture F_{OF′} refers to the neighboring picture of the current picture, which was previously restored and then stored to the buffer 340.

The adder 360 adds the prediction picture FPF to the residual picture F_{RB} provided from the lower layer. From a view of point of a block basis, the addition process may be referred to as a process of adding an inter prediction block P_{F}, which is contained in the prediction picture F_{PF}, and the residual block R_{B}, which is contained in the residual picture F_{RB}.

Thereafter, the fourth step is described below. A smoothing filter 370 smoothes the output F_{PF}+F_{RB} of the adder 360 using a smoothing filter.

A smoothing function for the smoothing filter may be implemented in various forms. For example, as described in Equation 7, when the resolutions of layers are the same, a deblock function may be used without change as the smoothing function for the smoothing filter. In contrast, when the resolutions of layers are different, a combination of a deblock function, a down-sampling function and an up-sampling function may be used as the smoothing function.

Furthermore, the smoothing function may have a form in which the boundary pixels of the smoothened block and their neighboring pixels are linearly coupled, as described in Equation 8. In particular, the neighboring pixels, as shown in FIGS. 5 and 6, are pixels that neighbor the boundary pixels, a weighted value of each of the boundary pixels may be defined as ½, and a weighted value of each of the neighboring pixels may be defined as ¼.

Finally, the fifth step is described below. An adder 330 adds the residual picture FRF provided from the inverse transform unit 320 to a picture generated by the smoothing. From a point of view of a block basis, the addition process may be referred to as a process of adding a block (F(P_{F}+R_{B}) of Equation 5) generated by the smoothing to a block RF contained in the residual picture F_{RF}. As the result of the addition of the adder 330, the current picture F_{OF} is finally restored.

Until now, in the descriptions of FIGS. 7 and 8, an example of coding a video frame that is formed of two layers has been described. However, the present invention is not limited to this, and may be applied to the coding of a video frame having a three or more layer structure.

In addition, in the descriptions of FIGS. 7 and 8, the video encoder 100 sends MV_{F} (motion vectors of the current layer) and MV_{B} (motion vectors of the lower layer) to the video decoder 300. However, it is possible that the video encoder 100 only sends MV_{B} and the video decoder 300 uses the MV_{B} as motion vectors of the current layer.

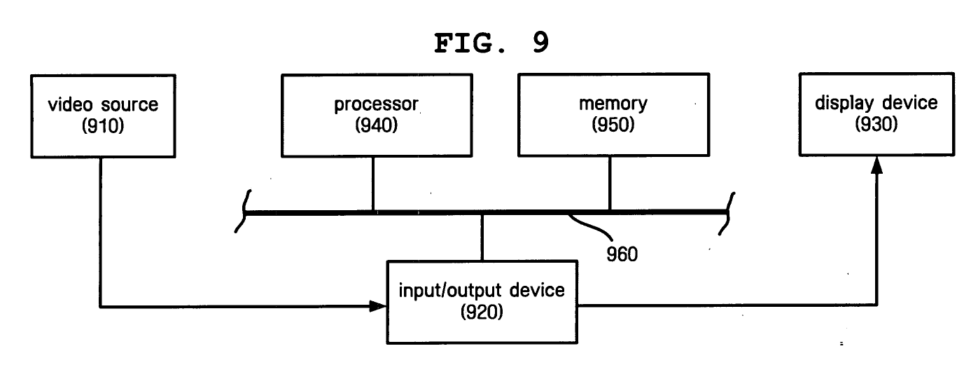

FIG. 9 is a diagram showing the construction of a system for implementing the video encoder 100 or the video decoder 300. The system may include a TV, set-top box, a desktop computer, a laptop computer, a palmtop computer, a Personal Digital Assistant (PDA), or a video or image storage device (for example, a Video Cassette Recorder (VCR), or a Digital Video Recorder (DVR)). Furthermore, the system may be formed of a combination of the above-described devices, or be formed such that one or more devices described above are contained in another device as part thereof. The system may include at least one video source 910, one or more input/output devices 920, a processor 940, memory 950, and a display device 930.

The video source 910 may be a TeleVision (TV) receiver, or a VCR or another video storage device. Furthermore, the source 910 may be one or more network connections for receiving video from a server using Internet, a Wide Area Network (WAN), a Local Area Network (LAN), a terrestrial broadcast system, a cable network, a satellite communication network, a wireless network, or a telephone network. Furthermore, the source may be formed of a combination of the above-described networks, or be formed such that one or more networks described-above are contained in another network as part thereof.

The input/output device 920, the processor 940, and the memory 950 perform communication through a communication medium 960. The communication medium 960 may be a communication bus, a communication network, or one or more internal connection circuits. Input video data received from the source 910 may be processed by the processor 940 based on one or more software programs stored in the memory 950, and may be processed by the processor 940 for the generation of output video provided to the display device 930.

In particular, the software programs stored in the memory 950 may include a scalable video codec for performing the methods according to the present invention. The encoder or the codec may be stored in the memory 950, or may be read from a storage medium, such as Compact Disc (CD)-Read Only Memory (ROM) or a floppy disc or downloaded from a predetermined server through various networks. The encoder or the codec may be replaced with software programs or hardware circuits, or may be replaced with a combination of the software programs and the hardware circuits.

The present invention can improve the performance of a codec using residual prediction or inter prediction.

In particular, the present invention can improve a codec using intra-base prediction depending on a low-complicated decoding condition.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multilayer-based video encoding method, comprising:
(a) calculating a difference between an inter prediction block for a block of a lower layer picture, which corresponds to an arbitrary block of a current picture, and a block of the lower layer picture;
(b) adding the calculated difference to an inter prediction block for the block of the current picture;
(c) smoothing a block, which is generated by the adding, using a smoothing filter; and
(d) encoding a difference between the block of the current picture and a block generated by the smoothing.

2. The multilayer-based video encoding method as set forth in claim 1, wherein the inter prediction block for the block of the lower layer picture and the inter prediction block for the block of the current picture are generated through a motion estimation process and a motion compensation process.

3. The multilayer-based video encoding method as set forth in claim 1, wherein, when a resolution of the current picture and a resolution of the lower layer picture are identical, a smoothing function for the smoothing filter is a deblock function.

4. The multilayer-based video encoding method as set forth in claim 1, wherein, when a resolution of the current picture and a resolution of the lower layer picture are not identical, a smoothing function for the smoothing filter is a combination of a deblock function, a down-sampling function, and an up-sampling function.

5. The multilayer-based video encoding method as set forth in claim 1, wherein a smoothing function for the smoothing filter is represented in a form in which boundary pixels of the smoothened block and neighboring pixels of the boundary pixels are linearly coupled.

6. The multilayer-based video encoding method as set forth in claim 5, wherein a weighted value of each of the boundary pixels is ½, and a weighted value of each of the neighboring pixels is ¼.

7. The multilayer-based video encoding method as set forth in claim 1, further comprising generating a bitstream including a flag, which indicates whether the encoded difference has been encoded through the operations (a) to (d), and the encoded difference.

8. The multilayer-based video encoding method as set forth in claim 1, wherein the operation (d) comprises:
generating transform coefficients by performing spatial transform on a difference;
generating quantized coefficients by quantizing the transform coefficients; and
encoding the quantized coefficients without loss.

9. A multilayer-based video encoding method, comprising:
(a) generating an inter prediction block for a block of a current picture;
(b) smoothing the generated inter prediction block using a smoothing filter;
(c) calculating a difference between the block of the current picture and a block generated by the smoothing; and
(d) encoding the difference.

10. The multilayer-based video encoding method as set forth in claim 9, wherein the inter prediction block is generated through a motion estimation process and a motion compensation process.

11. The multilayer-based video encoding method as set forth in claim 9, wherein a smoothing function for the smoothing filter is represented in a form in which boundary pixels of the smoothened block and neighboring pixels of the boundary pixels are linearly coupled.

12. The multilayer-based video encoding method as set forth in claim 11, wherein a weighted value of each of the boundary pixels is ½, and a weighted value of each of the neighboring pixels is ¼.

13. The multilayer-based video encoding method as set forth in claim 9, further comprising generating a bitstream including a flag, which indicates whether the encoded difference has been encoded through the operation (a) to (d), and the encoded difference.

14. A multilayer-based video decoding method, comprising:
(a) restoring residual signals of a block of a current picture, which is contained in an input bitstream, based on texture data for the block of the current picture;
(b) restoring residual signals of a block of a lower layer picture, which is contained in the input bitstream and corresponds to the block of the current picture;
(c) adding the restored residual signals of the block of the lower layer picture, which are restored at operation (b), to an inter prediction block for the current picture;
(d) smoothing a block, which is generated by the adding, using a smoothing filter; and
(e) adding the restored residual signals of the block of the current picture, which are restored at operation (a), to a block generated by the smoothing.

15. The multilayer-based video decoding method as set forth in claim 14, wherein, when a resolution of the current picture and a resolution of the lower layer picture are identical, a smoothing function for the smoothing filter is a deblock function.

16. The multilayer-based video decoding method as set forth in claim 14, wherein, when a resolution of the current picture and a resolution of the lower layer picture are not identical, a smoothing function for the smoothing filter is a combination of a deblock function, a down-sampling function, and an up-sampling function.

17. The multilayer-based video decoding method as set forth in claim 14, wherein a smoothing function for the smoothing filter is represented in a form in which boundary pixels of the smoothened block and neighboring pixels of the boundary pixels are linearly coupled.

18. The multilayer-based video decoding method as set forth in claim 17, wherein a weighted value of each of the boundary pixels is ½, and a weighted value of each of the neighboring pixels is ¼.

19. The multilayer-based video decoding method as set forth in claim 14, further comprising interpreting a flag indicating whether the block of the current picture has been encoded using smoothing prediction, wherein the operations (c) to (e) are performed according to a value of the flag.

20. The multilayer-based video decoding method as set forth in claim 14, wherein the operation (a) comprises performing a first inverse spatial transform on texture data for the block of the current picture, and dequantizing results obtained from the first inverse spatial transform;
wherein the operation (b) comprises performing a second inverse spatial transform on texture data for the block of the lower layer picture, and dequantizing results obtained from the second inverse spatial transform.

21. A multilayer-based video encoder, comprising;
a calculator which calculates a difference between an inter prediction block for a block of a lower layer picture, which corresponds to a block of a current picture, and the block of the lower layer picture;
an adder which adds the calculated difference to an inter prediction block for the block of the current picture;
a smoother which smoothes a block generated by the adder using a smoothing filter; and
an encoder which encodes a difference between the block of the current picture and a block generated by the smoother.

22. A multilayer-based video encoder, comprising;
a generator which generates an inter prediction block for a block of a current picture;
a smoother which smoothes the generated inter prediction block using a smoothing filter;
a calculator which calculates a difference between the block of the current picture and a block generated by the smoother; and
an encoder which encodes the difference.

23. A multilayer-based video decoder, comprising;
a first restorer which restores residual signals of a block of a current picture, which is contained in an input bitstream, based on texture data for the block of the current picture;
a second restorer which restores residual signals of a block of a lower layer picture, which is contained in the input bitstream and corresponds to the block of the current picture;
a first adder which adds the restored residual signals of the block of the lower layer picture to an inter prediction block for the current picture;
a smoother which smoothes a block generated by the first adder using a smoothing filter; and
a second adder which adds the restored residual signals of the block of the current picture to a block generated by the smoother.
